(19) United States
(12) Patent Application Publication
(10) Pub. No.: US 2024/0206688 A1
(43) Pub. Date: Jun. 27, 2024

(54) Handheld Foot Cleaning Device and Method of Use

(71) Applicant: Charles Bolling, San Diego, CA (US)

(72) Inventor: Charles Bolling, San Diego, CA (US)

(21) Appl. No.: 18/542,865

(22) Filed: Dec. 18, 2023

Related U.S. Application Data
(60) Provisional application No. 63/434,118, filed on Dec. 21, 2022.

(51) Int. Cl. A47K 7/02; A47K 7/04; B25G 1/04

(52) U.S. Cl. CPC A47K 7/026; A47K 7/04; B25G 1/043

(57) ABSTRACT

A toe and foot cleaning device comprising a telescoping handle with multiple sections that enable users to extend and retract the device to their desired length. One end of the handle includes a female threaded connector to enable the attachment of different toe and foot cleaning attachments. The handle has a spin or rotation switch for rotating the handle and a switch for adjusting the length of the handle. Each attachment has a male connector adapted to connect to the female threaded connector. The device has a fully extended length of about 36 inches and a retracted length of about 12 inches. The device and the attachments can be stored in a wall-mounted storage box.

### CROSS-REFERENCE TO RELATED APPLICATION

The present application claims priority to, and the benefit of, U.S. Provisional Application No. 63/434,118, which was filed on Dec. 21, 2022, and is incorporated herein by reference in its entirety.

### FIELD OF THE INVENTION

The present invention generally relates to the field of cleaning devices for feet. More specifically, the present invention relates to a novel toe cleaning device to accommodate all toe cleaning needs in a convenient and easy manner. The device features a telescoping handle which can be adjusted in length and can be rotated for a thorough cleaning. A plurality of toe cleaning attachments can be attached to the handle for cleaning the toe and foot. The device provides a thorough and customized toe cleaning experience and eliminates the potential of toe fungus or infection due to not being able to properly clean the toe. Accordingly, the present disclosure makes specific reference thereto. Nonetheless, it is to be appreciated that aspects of the present invention are also equally applicable to other like applications, devices, and methods of manufacture.

### BACKGROUND

By way of background, toes, like other parts of the body, can accumulate dirt, sweat, and bacteria. Accumulation of dirt and sweat can lead to unpleasant odors, fungal infections, and other skin problems. Different activities such as walking barefoot, wearing closed-toe shoes for extended periods, or participating in physical activities can lead to the accumulation of dirt, sweat, and bacteria. When dirt, sweat, and bacteria accumulate on toes, it can lead to the development of unpleasant odors. Bacteria can thrive in warm and moist environments, which are often found in the spaces between toes. Bacteria break down sweat and other substances in toes and release foul-smelling compounds, leading to foot odor. Fungi also can cause infections that result in itching, redness, and discomfort.

Cleaning toes is important for both hygiene and aesthetics. Proper toe cleaning helps remove dirt, sweat, and bacteria, promoting good foot hygiene and preventing potential health issues. Well-maintained toes, including clean and trimmed toenails, contribute to a neat and appealing appearance. However, cleaning the toes can be a challenging task. Adequate toe cleaning requires dexterity and coordination such as bending on knees to reach toes and to carefully clean the toes. Many individuals have difficulty reaching their toes due to factors like obesity, flexibility issues, or other physical limitations. Toe cleaning requires special tools which are difficult to use and handle. Individuals with limited physical strength and dexterity, such as the elderly or those with disabilities, face particular challenges in maintaining proper foot hygiene. They may require assistance or specialized tools to effectively clean their toes and feet. Individuals desire a toe cleaning tool that accommodates all toe cleaning needs in a convenient and easy manner.

Therefore, there exists a long-felt need in the art for a toe cleaning device that makes the toe cleaning process easier and more convenient. Additionally, there is a long-felt need in the art for a novel toe cleaning device that is easy to use and can be used by individuals of all ages. Moreover, there is a long-felt need in the art for a toe cleaning device that enables users to reach their toes comfortably without requiring much bending. Further, there is a long-felt need in the art for a multipurpose toe cleaning device that can accommodate different types of toe cleaning attachments. Furthermore, there is a long-felt need in the art for a toe cleaning device that includes a telescoping handle and interchangeable spinning heads or attachments for cleaning different areas of the toes. Also, there is a long-felt need in the art for a toe cleaning device that provides a thorough and customized toe cleaning experience. Finally, there is a long-felt need in the art for a toe cleaning device that makes toe cleaning easy and eliminates the potential of toe fungus or infection due to not being able to properly clean the toe.

The subject matter disclosed and claimed herein, in one embodiment thereof, comprises a toe cleaning device system. The system comprising a toe cleaning device designed for providing thorough cleaning of toes and feet, comprising a telescoping handle, a kit of detachable attachments, the attachments include one or more of football brushes, pumice brushes, and other types of brushes intended for cleaning and maintaining the hygiene of feet and toes. Each attachment has a male end which is adapted for engagement and fastening to a female threaded connector located on the toe cleaning device, facilitating secure attachment and detachment of the attachments to the device. The device is adapted to adjust in length using an extension button and a retraction button and to rotate clockwise and counterclockwise using spin buttons for providing a thorough cleaning of toes and feet. The device includes a motor for rotating the handle.

In this manner, the toe cleaning device system of the present invention accomplishes all of the foregoing objectives and provides users with a handheld toe cleaning device and attachments that provide a comprehensive and thorough cleaning of toes and feet. The telescoping handle of the device can be adjusted to a user's preferred length to accommodate users of different heights and enables for more comfortable and convenient use. The toe cleaning device can rotate 360 degrees, enhancing the ability to clean various areas of the feet effectively. The system is suitable for individuals with limited physical strength and dexterity, promoting independence in maintaining foot hygiene. Regular use of the toe cleaning device and the attachments help prevent toe fungus, infections, calluses, and other foot-related skin problems, contributing to overall foot health and hygiene.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld toe cleaning device. The toe cleaning device comprising a telescoping handle with a plurality of telescoping sections that can extend and retract the length of the handle. A length adjustment switch is disposed on the handle and is adapted to extend and retract the length of the handle. A spin or rotation switch is disposed on the handle to rotate the handle 360 degrees in both clockwise and counterclockwise directions. The device has a female connector at one end to receive and engage with a toe cleaning attachment, wherein the toe cleaning attachment is removably attached to the female connector.

In yet another embodiment, a foot cleaning device is disclosed. The device is handheld and is designed to facilitate convenient and effective toe cleaning and maintaining hygiene. The device includes a telescoping handle having telescopically engaged telescoping sections that can extend and retract the length of the handle according to user requirements. A first telescoping section features a female threaded connector for detachably attaching a toe cleaning attachment. A motor and a battery are disposed in the top end of the handle wherein the motor is used for rotating the handle upon activation of a spin or rotation switch. The toe cleaning attachment includes a male thread which engages with the female threaded connector for a secure connection, wherein the toe cleaning attachment is used for cleaning toes and feet.

In a further embodiment of the present invention, the toe cleaning attachment is selected from the group consisting of bristle brushes, pumice stones, sponge pads, and other exfoliating attachments.

In yet another embodiment, the extension button when pressed and held extends the handle and when released stops the extension, and the retraction button when pressed and held retracts the handle and when released stops the retraction.

In another aspect, the device has a fully extended length of three feet and a fully retracted length of one foot.

In yet another embodiment, a toe cleaning device system is disclosed. The system comprising a toe cleaning device designed for providing thorough cleaning of toes and feet, comprising a telescoping handle, a kit of detachable attachments, the attachments include one or more of football brushes, pumice brushes, and other types of brushes intended for cleaning and maintaining the hygiene of feet and toes. Each attachment has a male end which is adapted for engagement and fastening to a female threaded connector located on the toe cleaning device, facilitating secure attachment and detachment of the attachments to the device. The device is adapted to adjust in length and rotate clockwise and counterclockwise for providing a thorough cleaning of toes and feet.

In one embodiment, the male end and the female threaded connector are magnetic having opposite polarity, enabling for magnetic fastening of the attachment to the device.

In yet another aspect, the feet cleaning device is stored in a storage box. The storage box features a rack designed to securely accommodate the feet cleaning device. The storage box includes a plurality of storage spaces, each individual storage space is designed for storing one attachment from the set of attachments. The storage box has a hole in the rear wall thereof, enabling the mounting of the storage box on a wall-mounted hook.

A method for using a toe cleaning device to clean toes and maintain foot hygiene is described. The method includes the steps of providing the toe cleaning device, adjusting the length of the telescoping handle, fastening a toe cleaning attachment to the toe cleaning device by engaging the male end of the attachment with the female threaded connector on the device, and turning the handle either in a clockwise or a counterclockwise direction.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the toe cleaning device of the present invention in accordance with the disclosed structure;

FIG. 2 illustrates a plurality of toe cleaning attachments included with the toe cleaning handheld tool of the present invention in accordance with the disclosed structure;

FIG. 3 illustrates an enlarged view of the toe cleaning device showing a rotating ring coupled to the motor for rotating the handle in accordance with the disclosed structure;

FIG. 4 illustrates a perspective view showing a user cleaning toe using the toe cleaning handheld tool of the present invention in accordance with the disclosed structure; and

FIGS. 5A and 5B illustrate front and rear perspective views of one potential embodiment of the storage box for storing the toe cleaning device and the attachments in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a toe cleaning device that makes the toe cleaning process easier and more convenient. Additionally, there is a long-felt need in the art for a novel toe cleaning device that is easy to use and can be used by individuals of all ages. Moreover, there is a long-felt need in the art for a toe cleaning device that enables users to reach their toes comfortably without requiring much bending. Further, there is a long-felt need in the art for a multipurpose toe cleaning device that can accommodate different types of toe cleaning attachments. Furthermore, there is a long-felt need in the art for a toe cleaning device that includes a telescoping handle and interchangeable spinning heads or attachments for cleaning different areas of the toes. Also, there is a long-felt need in the art for a toe cleaning device that provides a thorough and customized toe cleaning experience. Finally, there is a long-felt need in the art for a toe cleaning device that makes toe cleaning easy and eliminates the potential of toe fungus or infection due to not being able to properly clean the toe.

The present invention, in one exemplary embodiment, is a handheld toe cleaning device. The toe cleaning device includes a telescoping handle with a plurality of telescoping sections that can extend and retract the length of the handle. The sections are telescopically engaged. A length adjustment switch is disposed on the handle and is adapted to extend and retract the length of the handle. A spin or rotation switch is disposed on the handle to rotate the handle 360 degrees in both clockwise and counterclockwise directions. The device has a female connector at one end to receive and engage with a toe cleaning attachment, wherein the toe cleaning attachment is removably attached to the female connector. The toe cleaning attachment includes a male connector for engaging with the female connector.

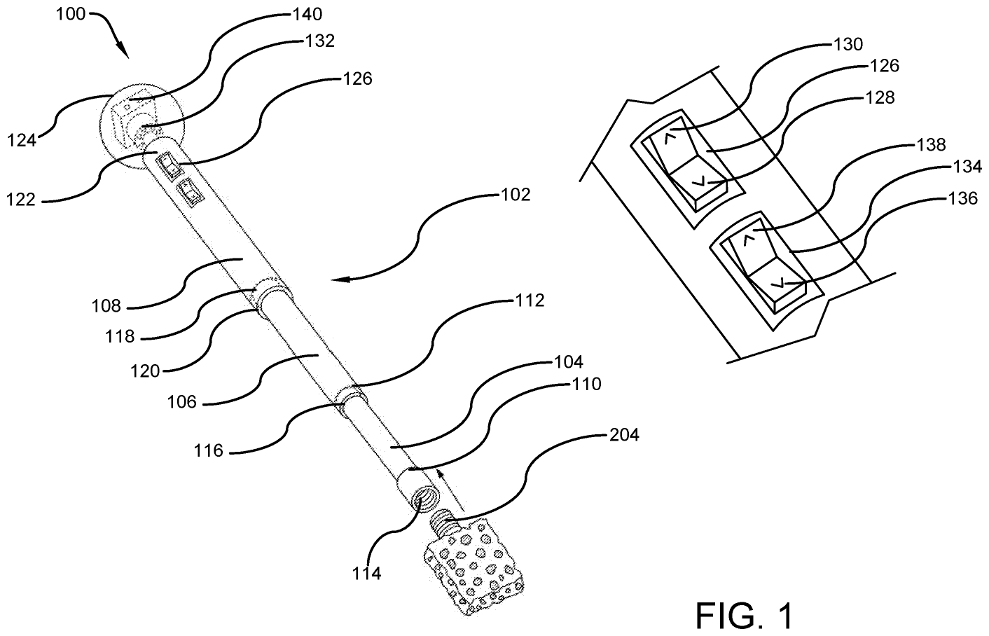

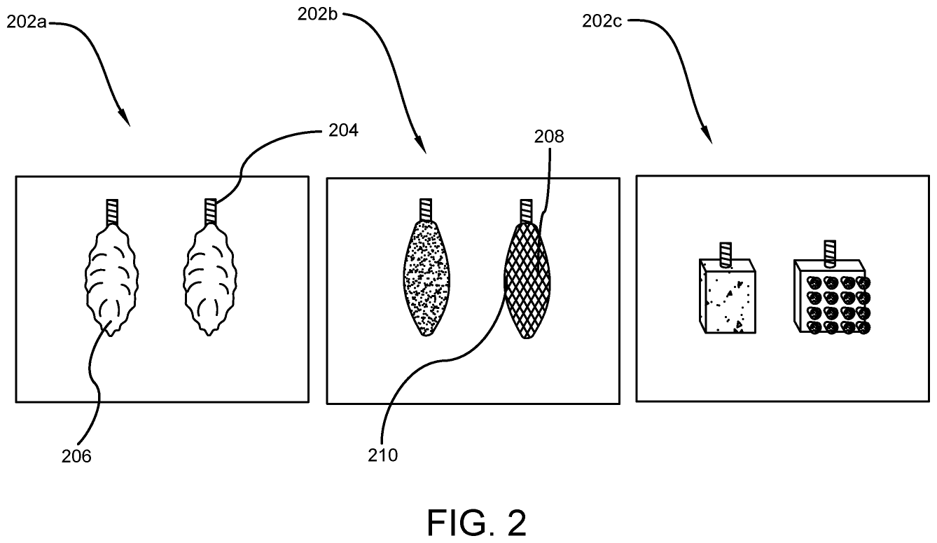

Referring initially to the drawings, FIG. 1 illustrates a perspective view of one potential embodiment of the toe cleaning device of the present invention in accordance with the disclosed structure. The toe and foot cleaning device 100 is designed as a handheld tool for enabling a user to easily reach toes for cleaning and maintaining hygiene. More specifically, the toe and foot cleaning handheld tool 100 includes a telescoping handle 102. The handle 102 includes a plurality of telescoping sections 104, 106, 108 to extend and retract the length of the handle 102 as per the requirements of a user. The first telescoping section 104 has a first end 110 and a second end 112. The first end 110 has a female threaded connector 114 for enabling a user to detachably attach a toe cleaning attachment as illustrated in FIG. 2. The second end 112 is telescopically engageable with the first end 116 of the second telescoping section 106. The second end 118 of the second telescoping section 106 is telescopically engageable with the first end 120 of the third telescoping section 108. The second end 122 of the telescoping section 108 is fixed and can include a protruding member 124 for helping a user to grip and hold the toe and foot cleaning tool 100.

It will be apparent to a person skilled in the art that the first telescoping section 104 is narrower than the second telescoping section 106 which in turn is narrower than the third telescoping section 108. The telescoping engagement between the telescoping sections prevents the telescoping sections from becoming detached from one another.

The telescoping handle 102 can be extended or retracted manually by pulling and pushing one or more telescoping sections. Alternatively, and preferably, the telescoping handle 102 can be automatically adjusted using a length adjustment switch 126 disposed on the handle 102. The length adjustment switch 126 includes an extension button 128 which when pressed and held extends the telescoping handle 102 by extending the sections 104, 106. The extension is automatically stopped when the extension button 128 is released. The length adjustment switch 126 includes a retraction button 130 which when pressed and held retracts the telescoping handle 102. The retraction of the handle 102 is automatically stopped when the retraction button 130 is released.

For providing a thorough cleaning of all the parts around a toe, the telescoping handle 102 can rotate 360 degrees using a miniature motor 132 which is included in the protruding member 124. The telescoping handle 102 includes a spin or rotation switch 134 for rotating the handle 102. More specifically, the spin or rotation switch 134 has a clockwise spin button 136 for rotating the handle 102 in the clockwise direction and has a counterclockwise spin button 138 for rotating the handle 102 in the counterclockwise direction.

In the fully extended length, the device 100 can have a length of about 36 inches (three feet), thereby obviating a user from bending while cleaning the toes and feet. In the fully retracted length, the device 100 can have a length of about 12 inches (1 foot). Along with the miniature motor 132, the protruding member 124 also stores a battery 140 which can be in the form of a button battery or any other conventional battery for providing automatic length adjustment and rotation of the handle 102 as described above.

In some embodiments, the protruding member 124 is integrated and alternatively, can be detachably attached to the handle 102. The device 100 can come in different colors and materials to meet the requirements of different users. Further, the device 100 is waterproof and is corrosion resistant. The device 100 can be made of any durable material like a metal, alloy, plastic, polymer, and more.

FIG. 2 illustrates a plurality of toe cleaning attachments included with the toe cleaning handheld tool of the present invention in accordance with the disclosed structure. The toe cleaning device 100 can provide thorough cleaning of toes and feet and can be used with a plurality of detachable attachments 202a-c which come in a kit along with the toe cleaning device 100. The detachable attachments 202a are preferably football brushes, 202b are pumice brushes, and 202c are other types of brushes used for cleaning and maintaining hygiene of feet and toes.

Each attachment as illustrated includes a male end 204 which is adapted to be engaged and fastened to the female threaded connector 114 of the toe cleaning device 100. In some embodiments, both the male end 204 and the female threaded connector 114 can be magnetic of opposite polarity for easy magnetic fastening of the attachment and the device 100. When an attachment is fastened, the attachment also rotates when the handle 102 rotates in either clockwise or counterclockwise directions.

Football brushes 202a are designed for cleaning and scrubbing between the toes. Football brushes 202a are usually shaped like a football and have a rounded tip 206 with bristles. The brushes 202a are used to gently scrub the skin between the toes to remove dirt, dead skin cells, and sweat, helping to prevent unpleasant odors and fungal infections.

Pumice brushes 202b have a pumice stone or pumice pad 208 with a brush component 210. The pumice stone or pad 208 is an abrasive material used to exfoliate and remove calluses and rough, dead skin from the feet, including the heels and the soles. The brush component 210 helps clean the skin and remove loosened debris.

Other types of brushes 202c can include sponge brushes which feature a soft sponge or foam surface on one side and a handle for grip. Flat brushes are rectangular or oval-shaped with bristles on the top side and are primarily used for cleaning the toenails and the skin around the nails.

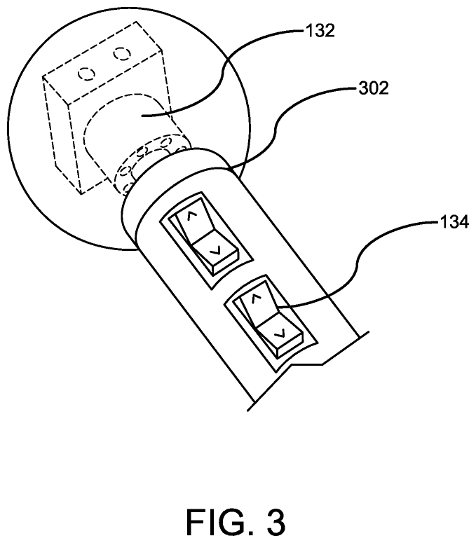

FIG. 3 illustrates an enlarged view of the toe cleaning device showing a rotating ring coupled to the motor for rotating the handle in accordance with the disclosed structure. In some embodiments, as illustrated, a rotating ring 302 is disposed in the handle 102 and is coupled to the motor 132. When the spin or rotation switch 134 is activated, the motor 132 rotates the rotating ring 302. The rotating ring 302 rotates the handle 102 to rotate the attachment attached to the handle 102 for providing an effective cleaning.

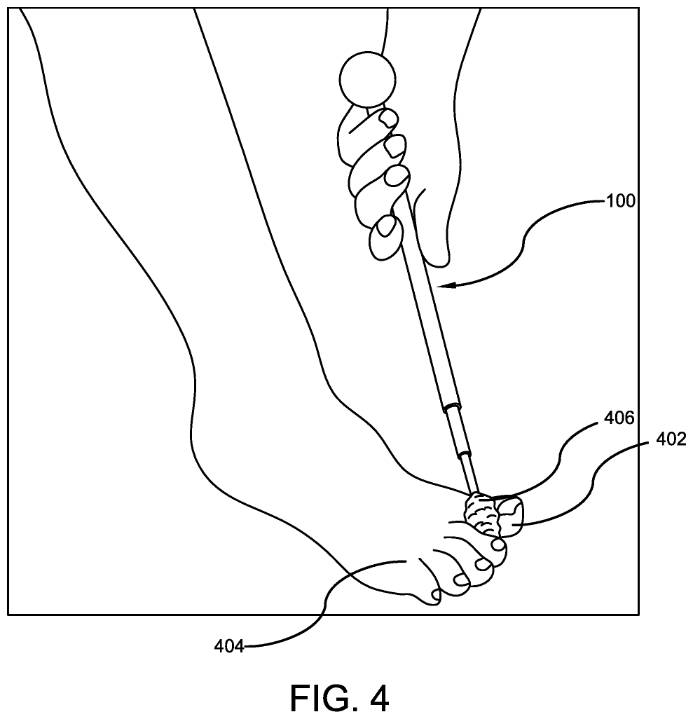

FIG. 4 illustrates a perspective view showing a user cleaning between toes using the toe cleaning handheld tool of the present invention in accordance with the disclosed structure. For using the device 100 to clean a toe 402 and foot 404, a user extends the device 100 to a desired length by using the extension button 128. Then, based on the cleaning requirement, the attachment 406 is fastened to the female connector 114 of the device 100. Then, the user holds the handle 102 and cleans the toe(s) 402. The handle 102 can rotate and retract as per the requirements of the user. It should be noted that the user is not required to bend over completely as the handle 102 can be extended up to three feet, thereby enabling easy cleaning operation of the feet.

The toe cleaning device 100 comes with multiple interchangeable spinning heads or attachments and each attachment may have a unique design or function, enabling users to target specific areas of their toes more effectively. By using the toe cleaning device, users can effectively clean and maintain their toe hygiene, reducing the risk of developing toe fungus or infections.

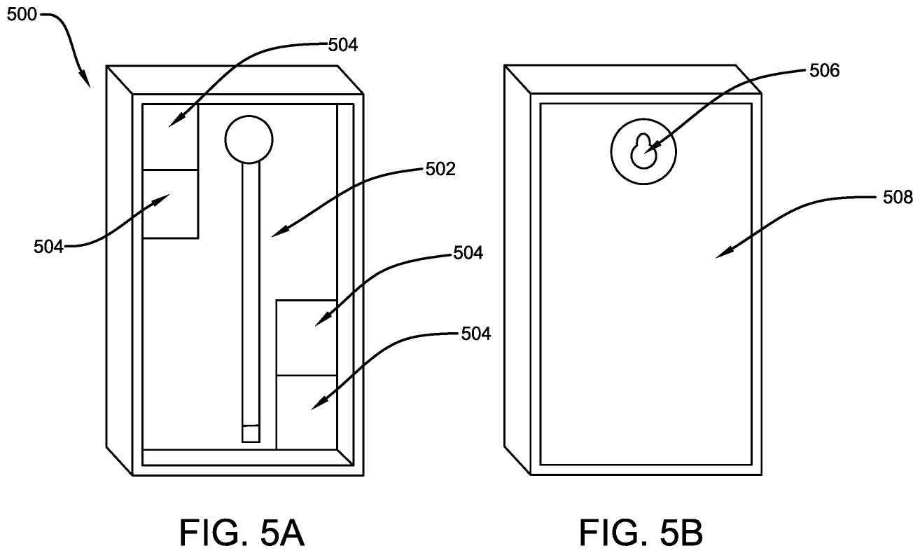

FIGS. 5A and 5B illustrate front and rear perspective views of one potential embodiment of the storage box for storing the toe cleaning device and the attachments in accordance with the disclosed structure. The present invention includes a storage box 500 for storing the feet cleaning device 100 and the attachments 202a-c. In the present embodiment, the storage box 500 is portable and includes a rack 502 for accommodating the cleaning device 100. A plurality of storage spaces 504 are included in the box 500 and each storage space 504 is designed to store an attachment. Referring now to FIG. 5B, a hole 506 is disposed in the rear wall 508 of the box 500 for mounting the box 500 to a wall-mounted hook such as of a washroom or vanity wall.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multifunctional foot hygiene device”, “foot cleaning device”, “toe cleaning device”, “handheld toe cleaning device”, and “device” are interchangeable and refer to the multifunctional foot hygiene handheld device 100 of the present invention.

Notwithstanding the foregoing, the multifunctional foot hygiene handheld device 100 of the present invention can be of any suitable size and configuration as is known in the art without affecting the overall concept of the invention, provided that it accomplishes the above-stated objectives. One of ordinary skill in the art will appreciate that the multifunctional foot hygiene handheld device 100 as shown in the FIGS. is for illustrative purposes only, and that many other sizes and shapes of the multifunctional foot hygiene handheld device 100 are well within the scope of the present disclosure. Although the dimensions of the multifunctional foot hygiene handheld device 100 are important design parameters for user convenience, the multifunctional foot hygiene handheld device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A toe and foot cleaning device comprising:
a toe and foot cleaning handheld device having a telescoping handle including a plurality of telescoping sections to extend and retract a length of said telescoping handle;
wherein said plurality of telescoping sections having a first telescoping section including a first end and a second end, further wherein said first end having a female threaded connector for enabling a user to detachably attach a toe and foot cleaning attachment;
wherein said second end is telescopically engageable with a first end of a second telescoping section;
wherein said second end of said second telescoping section is engageable with a first end of a third telescoping section; and
further wherein a second end of said third telescoping section having a protruding member for grasping by a user to grip and hold said toe and foot cleaning device.

2. The toe and foot cleaning device of claim 1, wherein said first telescoping section is narrower than said second telescoping section and said second telescoping section is narrower than said third telescoping section.

3. The toe and foot cleaning device of claim 2, wherein said telescoping handle extendable and retractable manually by pulling and pushing one or more of said first telescoping section, said second telescoping section, and said third telescoping section.

4. The toe and foot cleaning device of claim 2, wherein said telescoping handle having a first length adjustment switch and a length adjustment motor including an extension button for extending said plurality of telescoping sections while actuated.

5. The toe and foot cleaning device of claim 4, wherein said telescoping handle having a second length adjustment switch including a retraction button for retracting said plurality of telescoping sections while actuated.

6. The toe and foot cleaning device of claim 5, wherein said telescoping handle rotatable in 360 degrees.

7. The toe and foot cleaning device of claim 6, wherein said telescoping handle having a third rotation switch and a rotation motor including a clockwise button for rotating said telescoping handle clockwise while actuated.

8. The toe and foot cleaning device of claim 7, wherein said telescoping handle having a fourth rotation switch including a counterclockwise button for rotating said telescoping handle counterclockwise while actuated.

9. The toe and foot cleaning device of claim 8, wherein said telescoping handle having an adjustable length from 1 foot to 3 feet.

10. The toe and foot cleaning device of claim 9, wherein said telescoping handle having a battery for powering said length adjustment motor and said rotation motor.

11. A toe and foot cleaning device comprising:
a toe and foot cleaning handheld device having a telescoping handle including a plurality of telescoping sections to extend and retract a length of said telescoping handle and a plurality of toe and foot cleaning attachments for selectively attaching one of said plurality of toe and foot cleaning attachments to said telescoping handle;
wherein said plurality of telescoping sections having a first telescoping section including a first end and a second end, further wherein said first end having a female threaded connector for enabling a user to detachably attach said one of said plurality of toe and foot cleaning attachments;
wherein said second end is telescopically engageable with a first end of a second telescoping section;
wherein said second end of said second telescoping section is engageable with a first end of a third telescoping section;
wherein a second end of said third telescoping section having a protruding member for grasping by a user to grip and hold said toe and foot cleaning device; and
further wherein said plurality of toe and foot cleaning attachments selected from the group consisting of a football brush, a pumice brush, a sponge, and a flat brush.

12. The toe and foot cleaning device of claim 11, wherein said first telescoping section is narrower than said second telescoping section and said second telescoping section is narrower than said third telescoping section.

13. The toe and foot cleaning device of claim 12, wherein said telescoping handle extendable and retractable manually by pulling and pushing one or more of said first telescoping section, said second telescoping section, and said third telescoping section.

14. The toe and foot cleaning device of claim 12, wherein said telescoping handle having a first length adjustment switch and a length adjustment motor including an extension button for extending said plurality of telescoping sections while actuated.

15. The toe and foot cleaning device of claim 14, wherein said telescoping handle having a second length adjustment switch including a retraction button for retracting said plurality of telescoping sections while actuated.

16. The toe and foot cleaning device of claim 15, wherein said telescoping handle rotatable in 360 degrees.

17. The toe and foot cleaning device of claim 16, wherein said telescoping handle having a third rotation switch and a rotation motor including a clockwise button for rotating said telescoping handle clockwise while actuated.

18. The toe and foot cleaning device of claim 17, wherein said telescoping handle having a fourth rotation switch including a counterclockwise button for rotating said telescoping handle counterclockwise while actuated.

19. The toe and foot cleaning device of claim 18, wherein said telescoping handle having a battery for powering said length adjustment motor and said rotation motor.

20. A toe and foot cleaning device comprising:
a toe and foot cleaning handheld device having a telescoping handle including a plurality of telescoping sections to extend and retract a length of said telescoping handle and a plurality of toe and foot cleaning attachments for selectively attaching one of said plurality of toe and foot cleaning attachments to said telescoping handle;
wherein said plurality of telescoping sections having a first telescoping section including a first end and a second end, further wherein said first end having a female threaded connector for enabling a user to detachably attach said one of said plurality of toe and foot cleaning attachments;
wherein said second end is telescopically engageable with a first end of a second telescoping section;
wherein said second end of said second telescoping section is engageable with a first end of a third telescoping section;
wherein a second end of said third telescoping section having a protruding member for grasping by a user to grip and hold said toe and foot cleaning device;
wherein said plurality of toe and foot cleaning attachments selected from the group consisting of a football brush, a pumice brush, a sponge, and a flat brush; and
further wherein said telescoping handle having a rotation switch and a rotation motor for rotating said telescoping handle while actuated.
